(19) United States
(12) Patent Application Publication
(10) Pub. No.: US 2024/0419514 A1
(43) Pub. Date: Dec. 19, 2024

(54) Adaptive Locking Based on Measured Delays and Available Work

(71) Applicant: Dell Products L.P., Round Rock, TX (US)

(72) Inventor: Anton Rang, Houlton, WI (US)

(21) Appl. No.: 18/336,327

(22) Filed: Jun. 16, 2023

(51) Int. Cl. G06F 9/52

(52) U.S. Cl. CPC G06F 9/52

(57) ABSTRACT

A system can determine that a thread has failed to acquire a lock. The system can, in response to determining a thread has failed to acquire a lock, determine an average hold time and/or an average acquire time for threads that have previously acquired the lock. The system can compare the average hold time to a threshold hold time and/or compare the average acquire time to a threshold acquire time. The system can query a scheduler for a count of tasks which could be run. The system can determine whether a thread waiting to acquire a lock should spin or sleep based on at least one of an average hold time for the lock, an average acquire time for the lock, and a count of tasks which could be run.

### BACKGROUND

As part of using a processor, a number of operating systems, and some applications, use a decision process to determine whether a thread should run continuously on the processor until a lock applicable to the thread becomes available, or should “sleep” until the lock is available; however, both of these approaches introduce inefficiencies.

The above-described background is merely intended to provide a contextual overview of some current issues and is not intended to be exhaustive. Other contextual information may become further apparent upon review of the following detailed description.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

Embodiments of the present disclosure relate to the field of computers, and more particularly, to a method, a device, and a computer program product for adaptive locking for multicore CPUs.

An example system can operate as follows. The system can, in response to determining a thread has failed to acquire a lock, determine an average hold time for threads that have previously acquired the lock. The system can compare the average hold time to a threshold hold time.

An example method can comprise in response to identifying a failure of a thread to acquire a lock, determining, by a system comprising a processor, an average acquire time for threads that have previously acquired the lock. The method can further comprise comparing, by the system, the average acquire time to a threshold acquire time.

An example non-transitory computer-readable medium can comprise instructions that, in response to execution, cause a system comprising a processor to perform operations. These operations can comprise obtaining respective hold times for threads with respect to a lock. The operations can further comprise determining, based on the respective hold times, an average hold time for the threads. The operations can further comprise obtaining respective acquire times for the threads with respect to the lock. The operations can further comprise determining, based on the respective acquire times, an average acquire time for the threads. The operations can further comprise determining, in response to a seeking thread being determined to have failed to acquire the lock, whether the seeking thread is going to sleep or spin based on at least one of the average hold time or the average acquire time.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate adaptive locking for multicore CPUs, in accordance with an embodiment of this disclosure;

FIG. 2 illustrates another example system architecture that can facilitate adaptive locking for multicore CPUs, in accordance with an embodiment of this disclosure;

FIG. 3 illustrates an example process flow that can facilitate adaptive locking for multicore CPUs, in accordance with an embodiment of this disclosure;

FIG. 4 illustrates another example process flow that can facilitate adaptive locking for multicore CPUs, in accordance with an embodiment of this disclosure;

FIG. 5 illustrates another example process flow that can facilitate adaptive locking for multicore CPUs, in accordance with an embodiment of this disclosure;

FIG. 6 illustrates another example process flow that can facilitate adaptive locking for multicore CPUs, in accordance with an embodiment of this disclosure;

FIG. 7 illustrates another example process flow that can facilitate adaptive locking for multicore CPUs, in accordance with an embodiment of this disclosure;

FIG. 8 illustrates another example process flow that can facilitate adaptive locking for multicore CPUs, in accordance with an embodiment of this disclosure;

FIG. 9 illustrates another example process flow that can facilitate adaptive locking for multicore CPUs, in accordance with an embodiment of this disclosure;

FIG. 10 illustrates an example block diagram of a computer operable to execute an embodiment of this disclosure.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details. In other instances, well-known structures and devices are shown in block diagram form in order to facilitate describing the subject disclosure.

### Overview

Multicore processors, such as multicore central processing units (CPUs) or multicore co-processors, e.g., graphic processing units (GPUs), allow for simultaneous execution of multiple threads. Through this parallel processing, for instance, multicore CPUs can distribute tasks over multiple CPU cores that operate independently to facilitate efficiency and CPU performance. The multitasking capabilities of multicore CPUs necessitate synchronization mechanisms to prevent simultaneous alterations of the same resource. Concurrent operations, e.g., simultaneous operations, on the same resource by different threads running on different cores can lead to data inconsistencies or conflicts.

To address this issue, many systems comprising multicore CPUs utilize locking of data structures or other resources. In a multi-thread environment, locking ensures that multiple threads running on different CPU cores cannot simultaneously alter the same resource. For a thread running on a CPU to access a resource, the thread first acquires a lock associated with that resource. For example, the lock can be a read/write lock or a mutex (mutually exclusive) lock. While the thread holds the lock associated with the resource, the thread is free to access and operate on the resource without interference from other threads. Other threads also acquire the lock associated with the resource to operate on the resource, but the other threads cannot acquire a lock that is already held by another thread. When a thread is finished operating on a resource, the thread releases the lock and the lock becomes available for the other threads to acquire.

A thread that is directed to operate on a resource can attempt to acquire the lock associated with the resource. If another thread is holding the lock at the time the thread is attempting to acquire the lock, the thread will fail to acquire the lock and will be unable to operate on the resource for that time. The thread then waits until the holding thread releases the lock before it will be able to operate on the resource. The thread can repeatedly check the lock until the holding thread has released the lock and the thread can acquire it. This repeated checking of the lock is known as spinning. Alternatively, the thread can add itself to a list or queue associated with the resource maintained by the operating system or application. Once the thread is added to the list, the thread temporarily suspends execution, also known as sleeping.

When a thread is spinning, the thread maintains possession of the CPU core on which it is running. A spinning thread is run continuously on the CPU core while it waits for the lock to become available. Spinning utilizes CPU core time and power, but does no useful work while the thread is waiting. Additionally, it is possible for multiple threads to be spinning while waiting for the same lock. Sleeping threads relinquish their associated CPU cores once they have joined a waiting list or queue associated with the resource. The sleeping thread therefore does not consume CPU cycles for the duration of its sleep. A CPU core, however, must utilize CPU core resources to place the thread on the waiting list and to reawaken the thread when it is time for the thread to acquire the lock based on the waiting list.

The use of spinning within an operating system or application can reduce latency associated with the putting to sleep and reawakening of threads, however, spinning can also waste CPU core time and power that could have otherwise been directed towards useful work. The use of sleeping within an operating system or application can minimize such waste, but can cause latency due to frequent sleeping and reawakening of threads. Overuse of either spinning or sleeping threads can have negative impacts on system performance factors such as speed and efficiency. A combination of the two methods is typically desirable.

Some operating systems utilize a locking methodology that directs a thread to spin or sleep based on whether the thread holding the lock is currently running on another CPU core. In such operating systems, a waiting thread will spin if the holding thread is currently running on another CPU core and will sleep if it is not. Such a methodology rests on an assumption that a thread that has not temporarily stopped executing will quickly release the lock. When this assumption holds true, such a locking methodology can facilitate improved performance of an operating system.

Such a methodology can still result in low speed and efficiency in certain situations. In some cases, for example, a thread currently holding a lock can be currently running on another CPU core but can still hold the lock for a long time. For example, the holding thread may be commencing an operation that takes a long time to complete. For example, the holding lock may be carrying out an operation on a resource that requires 10,000 CPU core cycles. Based on the aforementioned methodology, a waiting thread would spin and could occupy a CPU core with non-useful work for up to 10,000 cycles. Further, additional threads may also attempt to operate on the locked resource and also spin while waiting, resulting in an even further waste of CPU core resources. If there are other threads waiting for an available CPU core, it is particularly wasteful for CPUs to spin to this extent.

In another example, a CPU could have many CPU cores available (e.g., 16 cores) so that many threads can execute at once. Some threads may need to acquire multiple locks associated with multiple resources to carry out their operations, and a thread can simultaneously hold one lock and be spinning for another lock. Because of this, chains of spinning threads can easily form as many threads competing for the same lock can all be spinning on CPU cores. Again, this amount of spinning is wasteful can have negative impacts on system performance, especially when other threads are waiting for an available CPU core.

Performance of an operating system or application can be improved compared to those utilizing known methods by implementing an adaptive locking protocol wherein a decision as to whether a waiting thread should spin or sleep is based on at least one of a historical average hold time, a historical average acquire time, and a presence or absence of other available work (e.g., threads). In an embodiment, a CPU can comprise a mechanism that measures relative time and a query mechanism capable of determining a count of tasks that could be run but are waiting for an available CPU core.

In an embodiment, a lock associated with a resource can comprise or otherwise be associated with a data structure configured to store hold times associated with the lock. In an embodiment, the data structure can be configured to store an average hold time and a count of hold times applied to the average. A hold time can represent an amount of time that a thread held the lock for. For example, a thread holding a lock can measure from a time that the thread acquires the lock until a time when the thread is ready to release the lock (i.e., by finishing the operation of the thread on the resource) and record that time as a hold time within the data structure and/or update the average hold time within the data structure based on the measured hold time. The thread can then immediately release the lock. For another example, the thread holding the lock can measure from a time that the thread acquires the lock until the time the thread predicts it will release the lock. For example, the thread can measure the amount of time from when it acquires the lock to when it completes its operation on the resource and can adjust the measured time based on the amount of additional time it will take for the thread to record the hold time and/or update an average hold time and release the lock.

In an embodiment, the thread can update an average hold time of the data structure associated with the lock based on the hold time being recorded by the thread and historical hold times already recorded in the data structure. For example, the average hold time can be the true mean of all entered hold times or a portion of the entered hold times, such as the 20 most recent hold times entered. In another example, the average hold time can be a decayed approximation of the entered hold times (e.g., 20% of the most recent hold time+80% of the previous average hold time). One advantage of utilizing a decayed approximation as the average hold time is that the system will be able to more quickly adapt to system behavior changes over time than would be possible by using a true average.

In an embodiment, the data structure associated with the lock can be configured to store acquire times associated with the lock. The acquire times can represent an amount of time that a thread waited to acquire the lock. For example, the thread can measure an amount of time starting from a time when the thread first attempted to acquire the lock until a time when the thread acquired the lock. The acquire time can depend on the hold times of other threads holding the lock before the current thread and a number of other threads currently waiting for the lock. The acquire time can be measured regardless of whether the thread was spinning or sleeping while it waited to acquire the lock. After acquiring the lock and at any time before the thread releases the lock, the thread can record its acquire time for the lock within the data structure.

In an embodiment, the thread can update an average acquire time of the data structure associated with the lock based on the acquire time being recorded by the thread and historical acquire times already recorded in the data structure. In an embodiment, the data structure can be configured to store an average acquire time and a count of acquire times applied to the average. For example, the average acquire time can be the true mean of all entered acquire times or a portion of the entered acquire times, such as the 20 most recent acquire times entered. In another example, the average acquire time can be a decayed approximation of the entered acquire times (e.g., 20% of the most recent acquire time+80% of the previous average acquire time). One advantage of utilizing a decayed approximation as the average acquire time is that the system will be able to more quickly adapt to system behavior changes over time than would be possible using a straight average.

The data structure associated with the lock of a resource can be configured to store one of an average hold time or an average acquire time or can be configured to store both an average hold time and an average acquire time. For both hold times and acquire times, the updating of averages can be protected by the lock itself and should be inexpensive to carry out. In an embodiment, one or both of the hold average and the acquire average can be updated only on occasion. For example, every fourth thread could update the one or both averages. Alternatively, the updating threads could be selected by a random number generator.

In an embodiment, the CPU scheduler can comprise a query mechanism capable of determining a count of tasks that could be run but are stuck waiting for an available CPU core. A thread can engage the query mechanism of the CPU to receive an indication of whether there are tasks waiting that could be run if a CPU core is made available (i.e., whether the count is 0). For another example, the thread can receive an indication of a count of threads waiting for an available CPU core.

In an embodiment, a thread can attempt and fail to acquire a lock associated with a resource through typical pre-existing mechanisms, such as an atomic CPU instruction. The threads failure to acquire the lock can indicate that another thread currently holds the lock. The thread can then determine whether the thread should spin or sleep.

In an embodiment, the thread can determine whether it should spin or sleep based on an average hold time associated with the lock. For example, a system can determine that a thread has failed to acquire a lock. In response to the determination that the thread has failed to acquire the lock, the system (e.g., the thread) can determine an average hold time for threads that have previously acquired the lock. For example, the average hold time can be a true mean or a decayed approximation as previously discussed. The system (e.g., the thread) can read a data structure associated with a lock even when the lock is held by another thread. The data structure can comprise an average hold time for the lock.

In an embodiment, the system, (e.g., the thread) can compare the average hold time with a pre-defined first threshold to determine whether it should sleep or spin. For example, if the average hold time exceeds the pre-defined first threshold, the thread can decide or be instructed to sleep, and if the average hold time does not exceed the pre-defined first threshold, the thread can decide or be instructed to spin. In an embodiment, the system (e.g., the thread) can receive an indication of whether there are tasks waiting that could be run if a CPU core is made available (e.g., whether a task count is zero or greater than zero). For example, if the average hold time exceeds the pre-defined first threshold and the task count is greater than zero, the thread will sleep. Otherwise, the thread will spin. In an embodiment, such a spinning thread can periodically redetermine if it should sleep. For example, a spinning thread can compare the average hold time and determine a task count every 200 CPU core cycles.

In an embodiment, the system (e.g., the thread) can compare the average hold time with a second threshold and a first threshold greater than the second threshold, and receive an indication of whether the task count is greater than zero or equal to zero. In an embodiment, the system can determine that the thread should sleep based on the average hold time exceeding the first threshold. In an embodiment, the system can determine that the thread should spin based on the average hold time not exceeding the second threshold. In an embodiment, the system can determine that the thread should spin based on the average hold time exceeding the second threshold and not exceeding the first threshold and an indication that the task count equals zero. In an embodiment, the system can determine that the thread should sleep based on the average hold time exceeding the second threshold and not exceeding the first threshold and an indication that the task count is greater than zero or another threshold task count value. In an embodiment, the first threshold and the second threshold can be based at least in part on an estimated latency of a sleep and wake-up sequence of a thread.

In an embodiment, the thread can determine whether it should spin or sleep based on an average acquire time associated with the lock. For example, a system can determine that a thread has failed to acquire a lock. In response to the determination that the thread has failed to acquire the lock, the system (e.g., the thread) can determine an average acquire time for threads that have previously acquired the lock. For example, the average acquire time can be a true mean or a decayed approximation as previously discussed. The system (e.g., the thread) can read a data structure associated with a lock even when the lock is held by another thread. The data structure can comprise an average acquire time for the lock.

In an embodiment, the system, (e.g., the thread) can compare the average acquire time with a pre-defined first threshold to determine whether it should sleep or spin. For example, if the average acquire time exceeds the pre-defined first threshold, the thread can decide or be instructed to sleep, and if the average acquire time does not exceed the pre-defined first threshold, the thread can decide or be instructed to spin. In an embodiment, the system (e.g., the thread) can receive an indication of whether there are tasks waiting that could be run if a CPU core is made available (e.g., whether a task count is zero or greater than zero). For example, if the average acquire time exceeds the pre-defined first threshold and the task count is greater than zero, the thread will sleep. Otherwise, the thread will spin. In an embodiment, such a spinning thread can periodically redetermine if it should sleep. For example, a spinning thread can compare the average acquire time and determine a task count every 200 CPU core cycles.

In an embodiment, the system (e.g., the thread) can compare the average acquire time with a second threshold and a first threshold greater than the second threshold, and receive an indication of whether the task count is greater than zero or equal to zero. In an embodiment, the system can determine that the thread should sleep based on the average acquire time exceeding the first threshold. In an embodiment, the system can determine that the thread should spin based on the average acquire time not exceeding the second threshold. In an embodiment, the system can determine that the thread should spin based on the average acquire time exceeding the second threshold and not exceeding the first threshold and an indication that the task count equals zero. In an embodiment, the system can determine that the thread should sleep based on the average acquire time exceeding the second threshold and not exceeding the first threshold and an indication that the task count is greater than zero or another threshold task count value. In an embodiment, the first threshold and the second threshold can be based at least in part on an estimated latency of a sleep and wake-up sequence of a thread.

In an embodiment, a data structure associated with a lock can be configured to hold multiple average hold times and/or multiple average acquire times corresponding to various classes of use. Such an embodiment accounts for a possibility that some types or classes of use for a thread holding a lock can require a much longer hold time than other types or classes of use. A thread can be associated with a class of use. For example, a thread can be associated with a class based on a purpose of a thread with reference to a particular resource and its associated lock. When the classified thread acquires the lock, the classified thread can update an average hold time and/or an average acquire time of the data structure for its associated class. The classified thread can also enter in the data structure an indicator of its classification. In an embodiment, the system (e.g., a thread attempting to acquire a lock) can read the data structure comprising the average hold times and the average acquire times for the one or more classes of use and the indicator of the classification of the currently holding thread. The data structure can further comprise an indicator of the classification of the thread currently holding the lock. The system (e.g., the waiting thread) can read and utilize the average hold time and/or average acquire time for the class of the currently holding thread. The number of classes can vary from one to a number matching the number of threads that have previously acquired the lock. In an embodiment, a small number of classes (e.g., three) representing broad purposes can be utilized. For example, threads may be classified into a first class when the thread operates on a resource for the purpose of a simple write. For another example, threads may be classified into a second class when the thread operates on the resource for the purpose of a simple read. For another example, threads may be classified into a third class when the thread operates on the resource for the purpose of performing a series or read and/or write operations.

In an embodiment, it is possible to allow a thread that has attempting to acquire a lock to spin for a pre-defined amount of time before determining whether the thread should spin or sleep in accordance with one or more embodiments presented herein. For example, a thread may attempt and fail to acquire a lock. The thread may start out by spinning for 40 CPU cycles. If the lock is not acquired by the 40^{th} cycle, the thread can then determine whether the thread should sleep or spin based on at least one of an average hold time of the lock, an average acquire time of the lock, and a pending task count of the CPU as described herein.

### Example Architectures

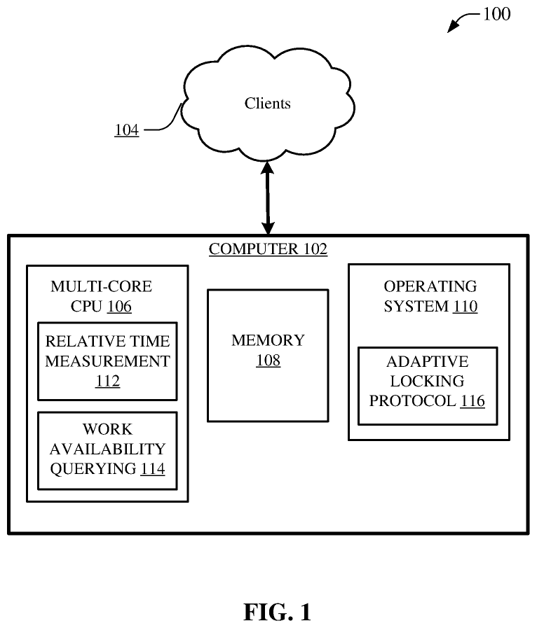

FIG. 1 illustrates an example system architecture 100 that can facilitate adaptive locking for multicore CPUs, in accordance with an embodiment of this disclosure.

System architecture 100 comprises computer 102 and communications network 104. In turn, source computer 102 comprises multicore central processing unit (CPU) 106, memory 108, and operating system 110. Multicore CPU 106 comprises relative time measurement 112 and work availability querying 114. Operating system 110 comprises adaptive locking protocol 116.

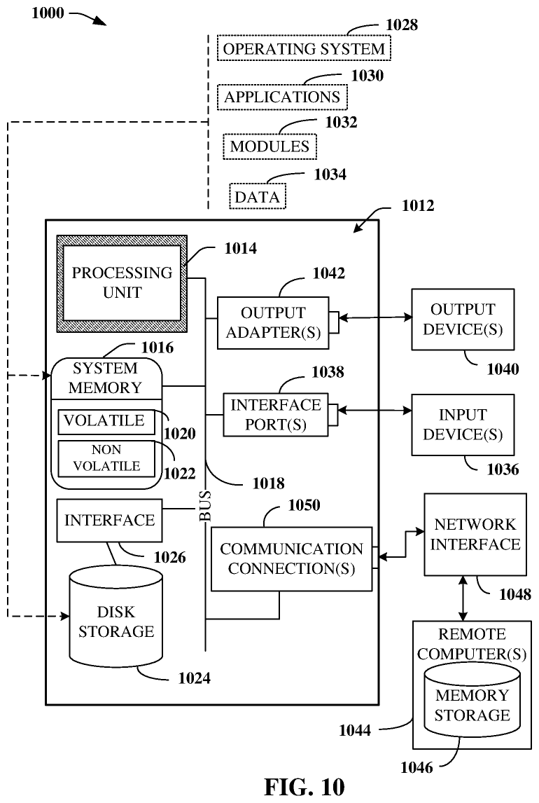

Computer 102 can be implemented with part(s) of computing environment 1000 of FIG. 10. Communications network 104 can comprise a computer communications network, such as the Internet.

Multicore processor 106 can comprise any number of CPU cores independently capable of running threads. Relative time measurement 112 of multicore processor 106 comprises a mechanism of measuring relative time. For example, relative time measurement can measure a duration of time in terms of seconds, microseconds, nanoseconds, and CPU cycles. Work availability querying 114 of multicore processor 106 can query a CPU scheduler to determine a count of available tasks that can be done pending availability of a CPU core. For example, the tasks can take the form of threads. In an embodiment, the work availability querying 114 can indicate a count of pending available tasks. In another embodiment, the work availability querying 114 can indicate a presence or absence or pending available tasks.

Operating system 110 can comprise adaptive locking protocol 116. Adaptive locking protocol 116 can determine whether a thread waiting to acquire a lock will sleep or spin in accordance with one or more embodiments presented herein.

It can be appreciated that system architecture 100 is one example system architecture for adaptive locking for multicore CPUs, and that there can be other system architectures that facilitate adaptive locking for a multicore CPUs.

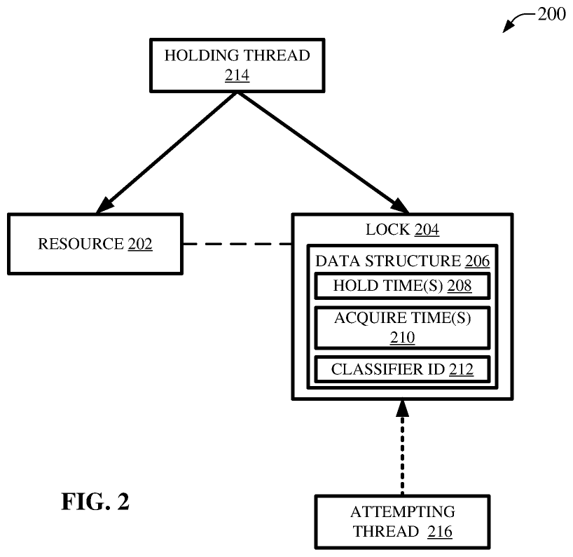

FIG. 2 illustrates another example system architecture 200 that can facilitate adaptive locking for a multicore CPUs, in accordance with an embodiment of this disclosure. In some examples, part(s) of system architecture 200 can be used to implement part(s) of system architecture 100 of FIG. 1.

System architecture 200 comprises a resource 202. A resource 202 can be any object of an operation of a thread by a CPU core. To prevent data inconsistencies and conflicts, only one thread may access and operate on resource 202 at a time. The prevention of simultaneous operations by multiple threads, lock 204 is associated with resource 202. Lock 204 can prevent any thread that is not currently holding the lock from operating on resource 202. In the system 200, holding thread 214 holds the lock 204 and therefore may operate on resource 202. Holding thread 214 can similarly alter data of lock 204. Lock 204 comprises a data structure 206 that stores information associated with the lock. Data structure 206 can comprise one or more hold times 208 associated with the lock, including one or more average hold times. Data structure 206 can comprise one or more acquire times 210 associated with the lock, including one or more average acquire times. Data structure 206 can comprise a classifier ID 212 that indicates a class of a holding thread 214.

Attempting thread 216 is a thread running on a CPU core that is attempting to acquire lock 204 so that it may operate on resource 202. Since the lock 204 is currently held by holding thread 214, attempting thread 216 is unable to hold the lock and is not able to operate on or alter resource 202 or lock 204. Attempting thread 216 is able to read data structure 206. In an embodiment, attempting thread 216 will either sleep or spin while it waits for lock 204 based on information from data structure 206.

### Example Process Flows

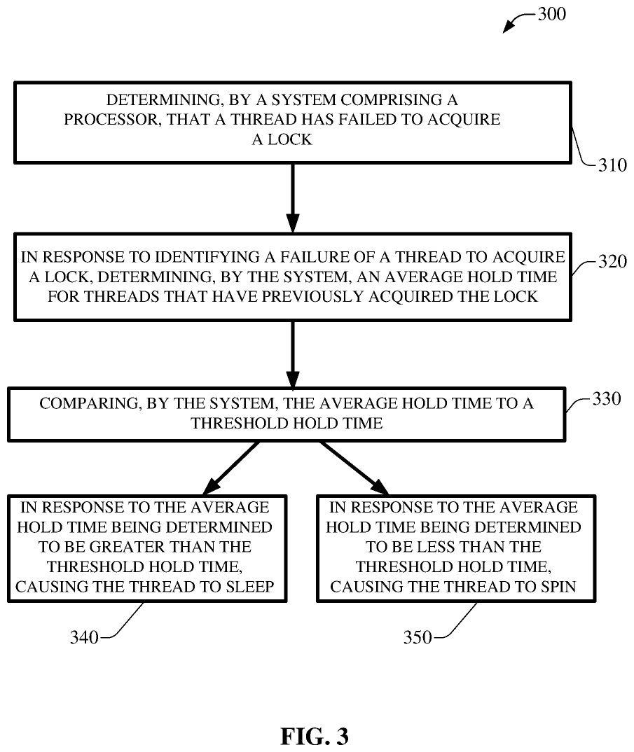

FIG. 3 illustrates an example process flow 300 that can facilitate adaptive locking for multicore CPUs in accordance with an embodiment of this disclosure. In some examples, one or more embodiments of process flow 300 can be implemented by systems 100 and 200 of FIGS. 1 and 2, or computing environment 1000 of FIG. 10. Repetitive description of like elements and/or processes employed in respective embodiments is omitted for sake of brevity.

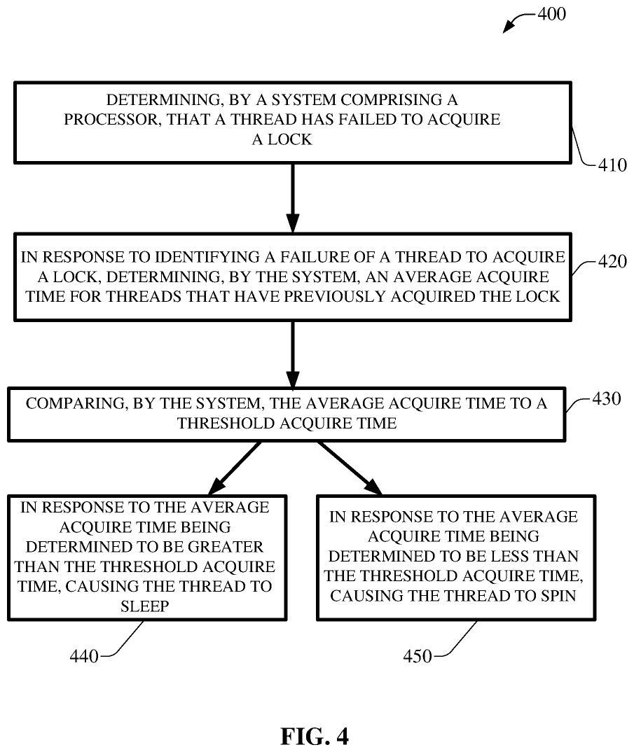

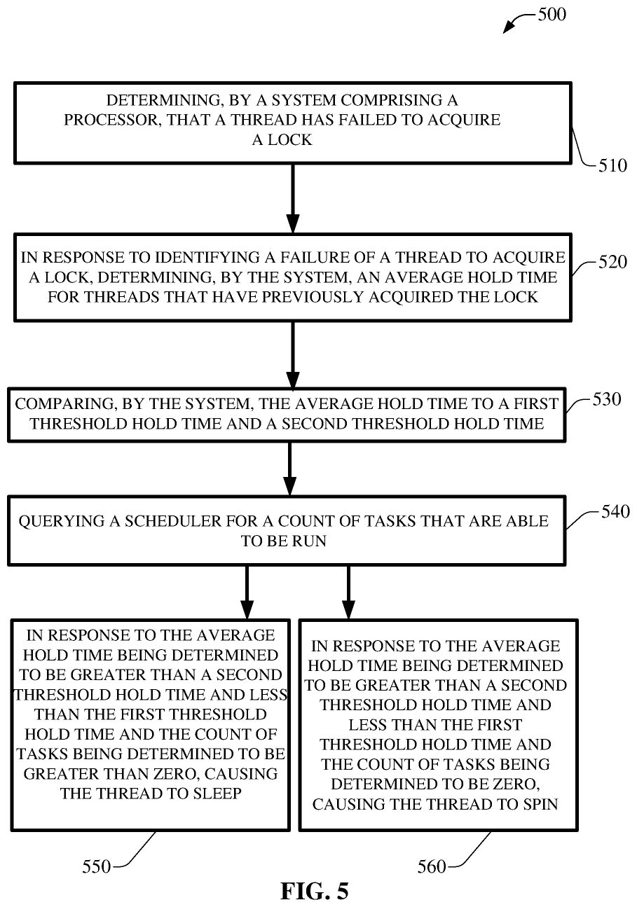

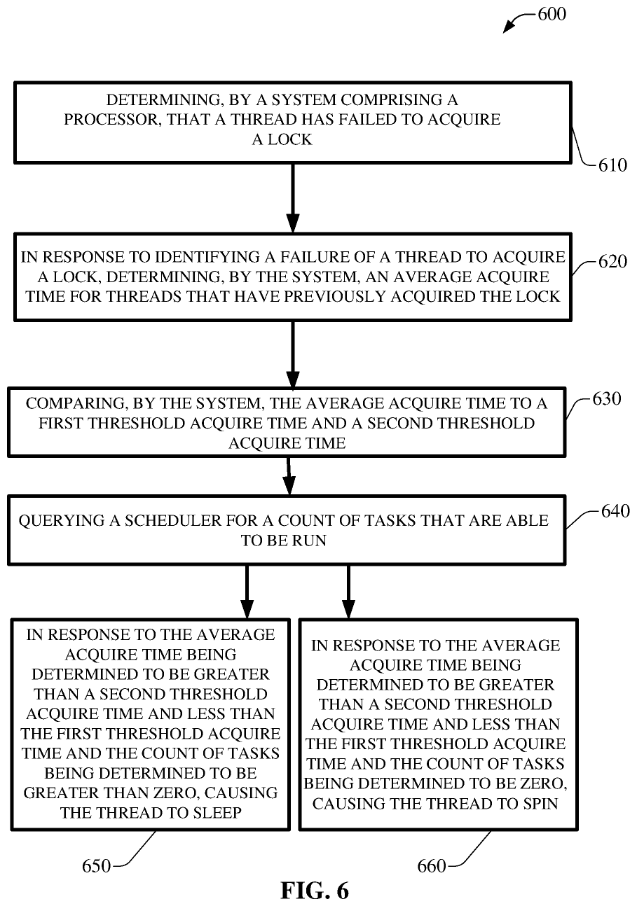

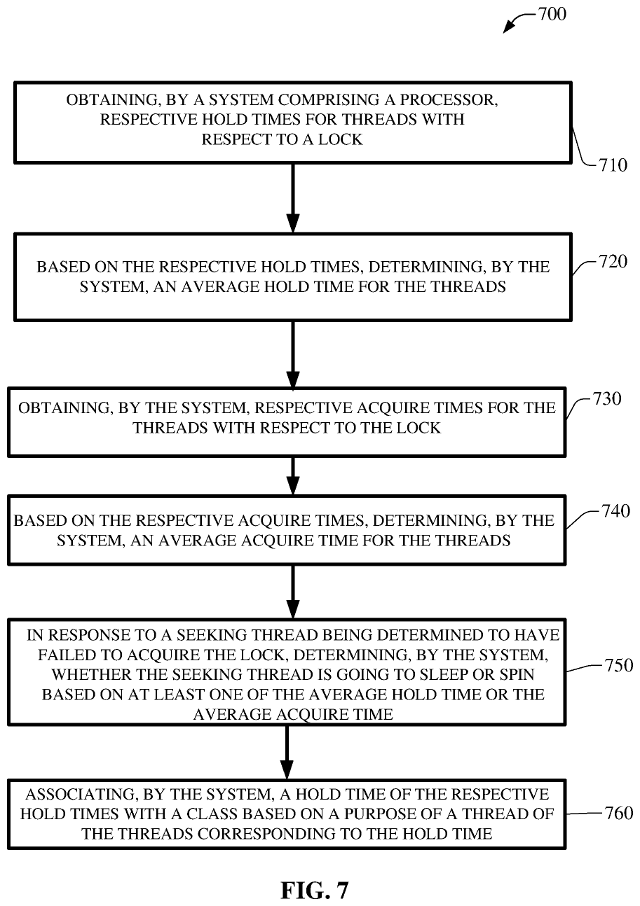

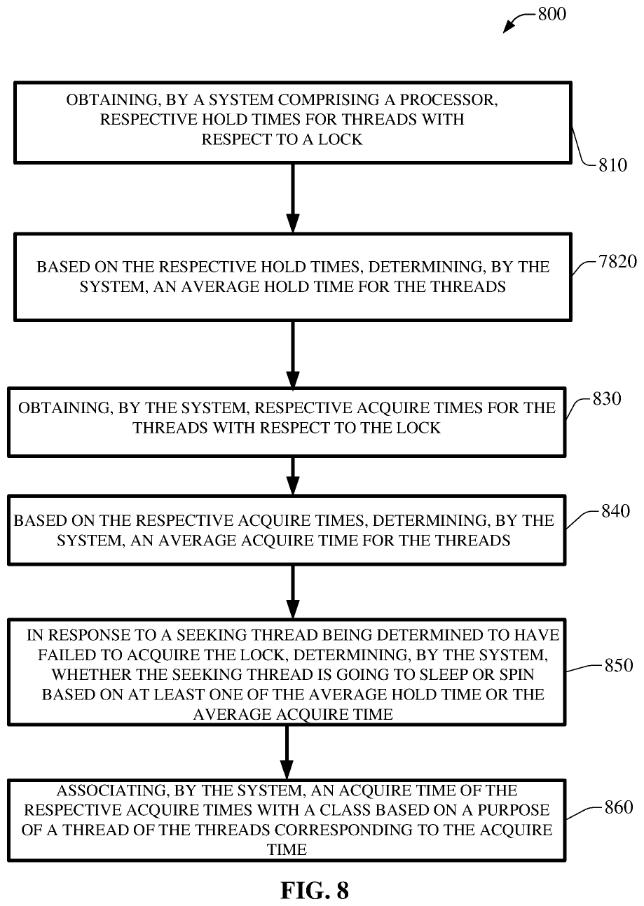

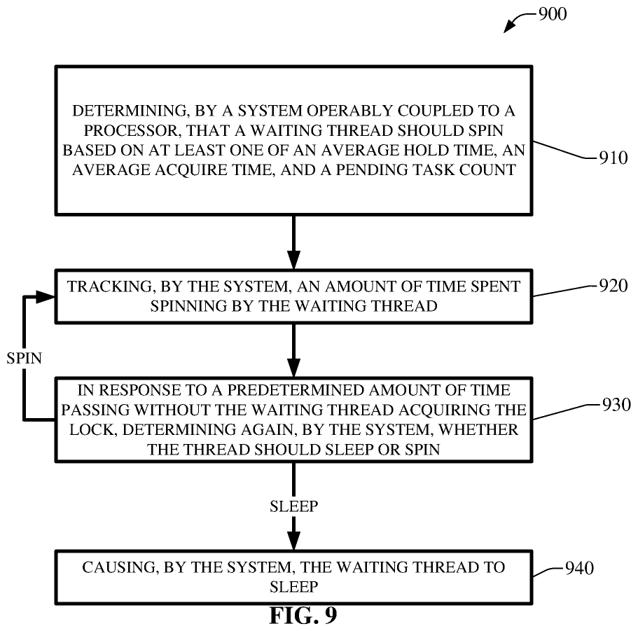

It can be appreciated that the operating procedures of process flow 300 are example operating procedures, and that there can be embodiments that implement more or fewer operating procedures than are depicted, or that implement the depicted operating procedures in a different order than as depicted. In some examples, process flow 300 can be implemented in conjunction with one or more embodiments of one or more of process flow 400 of FIG. 4, process flow 500 of FIG. 5, process flow 600 of FIG. 6, process flow 700 of FIG. 7, process flow 800 of FIG. 8, and/or process flow 900 of FIG. 9.

Process flow 300 begins with 310, and moves to operation 320.

Operation 310 depicts determining, by a system comprising a processor, that a thread has failed to acquire a lock.

Operation 320 depicts in response to identifying a failure of a thread to acquire a lock, determining, by the system, an average hold time for threads that have previously acquired the lock.

Operation 330 depicts comparing, by the system, the average hold time to a threshold hold time.

Operation 340 depicts in response to the average hold time being determined to be greater than the threshold hold time, causing the thread to sleep.

Operation 350 depicts in response to the average hold time being determined to be less than the threshold hold time, causing the thread to spin.

FIG. 4 illustrates an example process flow 400 that can facilitate adaptive locking for multicore CPUs in accordance with an embodiment of this disclosure. In some examples, one or more embodiments of process flow 400 can be implemented by systems 100 and 200 of FIGS. 1 and 2, or computing environment 1000 of FIG. 10. Repetitive description of like elements and/or processes employed in respective embodiments is omitted for sake of brevity.

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of one or more of process flow 300 of FIG. 3, process flow 500 of FIG. 5, process flow 600 of FIG. 6, process flow 700 of FIG. 7, process flow 800 of FIG. 8, and/or process flow 900 of FIG. 9.

Process flow 400 begins with 410, and moves to operation 420.

Operation 410 depicts determining, by a system comprising a processor, that a thread has failed to acquire a lock.

Operation 420 depicts, in response to identifying a failure of a thread to acquire a lock, determining, by the system, an average acquire time for threads that have previously acquired the lock.

Operation 430 depicts comparing, by the system, the average acquire time to a threshold acquire time.

Operation 440 depicts, in response to the average acquire time being determined to be greater than the threshold acquire time, causing the thread to sleep.

Operation 450 depicts, in response to the average acquire time being determined to be less than the threshold acquire time, causing the thread to spin.

FIG. 5 illustrates an example process flow 500 that can facilitate adaptive locking for multicore CPUs in accordance with an embodiment of this disclosure. In some examples, one or more embodiments of process flow 500 can be implemented by systems 100 and 200 of FIGS. 1 and 2, or computing environment 1000 of FIG. 10. Repetitive description of like elements and/or processes employed in respective embodiments is omitted for sake of brevity.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 300 of FIG. 3, process flow 400 of FIG. 4, process flow 600 of FIG. 6, process flow 700 of FIG. 7, process flow 800 of FIG. 8, and/or process flow 900 of FIG. 9.

Process flow 500 begins with 510, and moves to operation 520.

Operation 510 depicts determining, by a system comprising a processor, that a thread has failed to acquire a lock.

Operation 520 depicts, in response to identifying a failure of a thread to acquire a lock, determining, by the system, an average hold time for threads that have previously acquired the lock.

Operation 530 depicts comparing, by the system, the average hold time to a first threshold hold time and a second threshold hold time.

Operation 540 depicts querying a scheduler for a count of tasks that are able to be run.

Operation 550 depicts, in response to the average hold time being determined to be greater than a second threshold hold time and less than the first threshold hold time and the count of tasks being determined to be greater than zero, causing the thread to sleep.

Operation 560 depicts, in response to the average hold time being determined to be greater than a second threshold hold time and less than the first threshold hold time and the count of tasks being determined to be zero, causing the thread to spin.

FIG. 6 illustrates an example process flow 600 that can facilitate adaptive locking for multicore CPUs in accordance with an embodiment of this disclosure. In some examples, one or more embodiments of process flow 600 can be implemented by systems 100 and 200 of FIGS. 1 and 2, or computing environment 1000 of FIG. 10. Repetitive description of like elements and/or processes employed in respective embodiments is omitted for sake of brevity.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 300 of FIG. 3, process flow 400 of FIG. 4, process flow 500 of FIG. 5, process flow 700 of FIG. 7, process flow 800 of FIG. 8, and/or process flow 900 of FIG. 9.

Process flow 600 begins with 610, and moves to operation 620.

Operation 610 depicts determining, by a system comprising a processor, that a thread has failed to acquire a lock.

Operation 620 depicts, in response to identifying a failure of a thread to acquire a lock, determining, by the system, an average acquire time for threads that have previously acquired the lock.

Operation 630 depicts comparing, by the system, the average acquire time to a first threshold acquire time and a second threshold acquire time.

Operation 640 depicts querying a scheduler for a count of tasks that are able to be run.

Operation 650 depicts, in response to the average acquire time being determined to be greater than a second threshold acquire time and less than the first threshold acquire time and the count of tasks being determined to be greater than zero, causing the thread to sleep.

Operation 660 depicts, in response to the average acquire time being determined to be greater than a second threshold acquire time and less than the first threshold acquire time and the count of tasks being determined to be zero, causing the thread to spin.

FIG. 7 illustrates an example process flow 700 that can facilitate adaptive locking for multicore CPUs in accordance with an embodiment of this disclosure. In some examples, one or more embodiments of process flow 700 can be implemented by systems 100 and 200 of FIGS. 1 and 2, or computing environment 1000 of FIG. 10. Repetitive description of like elements and/or processes employed in respective embodiments is omitted for sake of brevity.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 300 of FIG. 3, process flow 400 of FIG. 4, process flow 500 of FIG. 5, process flow 600 of FIG. 6, process flow 800 of FIG. 8, and/or process flow 900 of FIG. 9.

Process flow 700 begins with 710, and moves to operation 720.

Operation 710 depicts obtaining, by a system comprising a processor, respective hold times for threads with respect to a lock.

Operation 720 depicts based on the respective hold times, determining, by the system, an average hold time for the threads.

Operation 730 depicts obtaining, by the system, respective acquire times for the threads with respect to the lock.

Operation 740 depicts, based on the respective acquire times, determining, by the system, an average acquire time for the threads.

Operation 750 depicts, in response to a seeking thread being determined to have failed to acquire the lock, determining, by the system, whether the seeking thread is going to sleep or spin based on at least one of the average hold time or the average acquire time.

Operation 760 depicts associating, by the system, a hold time of the respective hold times with a class based on a purpose of a thread of the threads corresponding to the hold time.

FIG. 8 illustrates an example process flow 800 that can facilitate adaptive locking for multicore CPUs in accordance with an embodiment of this disclosure. In some examples, one or more embodiments of process flow 800 can be implemented by systems 100 and 200 of FIGS. 1 and 2, or computing environment 1000 of FIG. 10. Repetitive description of like elements and/or processes employed in respective embodiments is omitted for sake of brevity.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 300 of FIG. 3, process flow 400 of FIG. 4, process flow 500 of FIG. 5, process flow 600 of FIG. 6, process flow 700 of FIG. 7, and/or process flow 900 of FIG. 9.

Process flow 800 begins with 810, and moves to operation 820.

Operation 810 depicts obtaining, by a system comprising a processor, respective hold times for threads with respect to a lock.

Operation 820 depicts, based on the respective hold times, determining, by the system, an average hold time for the threads.

Operation 830 depicts obtaining, by the system, respective acquire times for the threads with respect to the lock.

Operation 840 depicts, based on the respective acquire times, determining, by the system, an average acquire time for the threads.

Operation 850 depicts in response to a seeking thread being determined to have failed to acquire the lock, determining, by the system, whether the seeking thread is going to sleep or spin based on at least one of the average hold time or the average acquire time.

Operations 860 depicts associating, by the system, an acquire time of the respective acquire times with a class based on a purpose of a thread of the threads corresponding to the acquire time.

FIG. 9 illustrates an example process flow 900 that can facilitate adaptive locking for multicore CPUs in accordance with an embodiment of this disclosure. In some examples, one or more embodiments of process flow 900 can be implemented by systems 100 and 200 of FIGS. 1 and 2, or computing environment 1000 of FIG. 10. Repetitive description of like elements and/or processes employed in respective embodiments is omitted for sake of brevity.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 300 of FIG. 3, process flow 400 of FIG. 4, process flow 500 of FIG. 5, process flow 600 of FIG. 6, process flow 700 of FIG. 7, and/or process flow 800 of FIG. 8.

Process flow 900 begins with 910, and moves to operation 920.

Operation 910 depicts determining, by a system operably coupled to a processor, that a waiting thread should spin based on at least one of an average hold time, an average acquire time, and a pending task count.

Operation 920 depicts tracking, by the system, an amount of time spent spinning by the waiting thread.

Operation 930 depicts, in response to a predetermined amount of time passing without the waiting thread acquiring the lock, determining again, by the system, whether the thread should sleep or spin.

Operation 940 depicts causing, by the system, the waiting thread to sleep.

### Example Operating Environment

In order to provide additional context for various embodiments described herein, FIG. 10 and the following discussion are intended to provide a brief, general description of a suitable computing environment 1000 in which the various embodiments of the embodiment described herein can be implemented.

For example, parts of computing environment 1000 can be used to implement one or more embodiments of computer 102 of FIG. 1.

In some examples, computing environment 1000 can implement one or more embodiments of the process flows of FIGS. 3-9 to facilitate maintaining data integrity for backed up files.

While the embodiments have been described above in the general context of computer-executable instructions that can run on one or more computers, those skilled in the art will recognize that the embodiments can be also implemented in combination with other program modules and/or as a combination of hardware and software.

In order to provide a context for the various elements of the disclosed subject matter, the following discussion is intended to provide a brief, general description of a suitable environment in which the various embodiments of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. One or more embodiments described and suggested herein can also be practiced in distributed computing environments where tasks are performed by remote processing devices that are linked through a communications network; however, some if not all parts of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012 can comprise a processing unit 1014, a system memory 1016, and a system bus 1018. System bus 1018 couples system components comprising, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) comprising a memory bus or a memory controller, a peripheral bus or an external bus, and/or a local bus using any variety of available bus architectures comprising, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (Institute of Electrical and Electronics Engineers 1194), and small computer systems interface.

System memory 1016 can comprise volatile memory 1020 and nonvolatile memory 1022. A basic input/output system, containing routines to transfer information between elements within computer 1012, such as during start-up, can be stored in nonvolatile memory 1022. By way of illustration, and not limitation, nonvolatile memory 1022 can comprise read only memory, programmable read only memory, electrically programmable read only memory, electrically erasable read only memory, or flash memory. Volatile memory 1020 comprises read only memory, which acts as external cache memory. By way of illustration and not limitation, read only memory is available in many forms such as synchronous random access memory, dynamic read only memory, synchronous dynamic read only memory, double data rate synchronous dynamic read only memory, enhanced synchronous dynamic read only memory, SynchLink dynamic read only memory, Rambus direct read only memory, direct Rambus dynamic read only memory, and Rambus dynamic read only memory.

Computer 1012 can also comprise removable/non-removable, volatile/non-volatile computer storage media. FIG. 10 illustrates, for example, disk storage 1024. Disk storage 1024 comprises, but is not limited to, devices like a magnetic disk drive, floppy disk drive, tape drive, flash memory card, or memory stick. In addition, disk storage 1024 can comprise storage media separately or in combination with other storage media comprising, but not limited to, an optical disk drive such as a compact disk read only memory device, compact disk recordable drive, compact disk rewritable drive or a digital versatile disk read only memory. To facilitate connection of the disk storage devices 1024 to system bus 1018, a removable or non-removable interface is typically used, such as interface 1026.

Computing devices typically comprise a variety of media, which can comprise computer-readable storage media or communications media, which two terms are used herein differently from one another as follows.

Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, read only memory, programmable read only memory, electrically programmable read only memory, electrically erasable read only memory, flash memory or other memory technology, compact disk read only memory, digital versatile disk or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can comprise non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software comprises an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. In some embodiments, a user interface can allow entry of user preference information, etc., and can be embodied in a touch sensitive display panel, a mouse/pointer input to a graphical user interface (GUI), a command line controlled interface, etc., allowing a user to interact with computer 1012. Input devices 1036 comprise, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 comprise, for example, a serial port, a parallel port, a game port, a universal serial bus, an infrared port, a Bluetooth port, an IP port, or a logical port associated with a wireless service, etc. Output device(s) 1040 use some of the same type of ports as input device(s) 1036.

Thus, for example, a universal serial bus port can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 comprise, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, a cloud service, code executing in a cloud-computing environment, a workstation, a microprocessor-based appliance, a peer device, or other common network node and the like, and typically comprises many or all of the elements described relative to computer 1012. A cloud computing environment, the cloud, or other similar terms can refer to computing that can share processing resources and data to one or more computer and/or other device(s) on an as needed basis to enable access to a shared pool of configurable computing resources that can be provisioned and released readily. Cloud computing and storage solutions can store and/or process data in third-party data centers which can leverage an economy of scale and can view accessing computing resources via a cloud service in a manner similar to a subscribing to an electric utility to access electrical energy, a telephone utility to access telephonic services, etc.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local area networks and wide area networks. Local area network technologies comprise fiber distributed data interface, copper distributed data interface, Ethernet, Token Ring and the like. Wide area network technologies comprise, but are not limited to, point-to-point links, circuit-switching networks like integrated services digital networks and variations thereon, packet switching networks, and digital subscriber lines. As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can comprise, for example, internal and external technologies such as modems, comprising regular telephone grade modems, cable modems and digital subscriber line modems, integrated services digital network adapters, and Ethernet cards.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. Moreover, the use of any particular embodiment or example in the present disclosure should not be treated as exclusive of any other particular embodiment or example, unless expressly indicated as such, e.g., a first embodiment that has aspect A and a second embodiment that has aspect B does not preclude a third embodiment that has aspect A and aspect B. The use of granular examples and embodiments is intended to simplify understanding of certain features, aspects, etc., of the disclosed subject matter and is not intended to limit the disclosure to said granular instances of the disclosed subject matter or to illustrate that combinations of embodiments of the disclosed subject matter were not contemplated at the time of actual or constructive reduction to practice.

Further, the term “include” is intended to be employed as an open or inclusive term, rather than a closed or exclusive term. The term “include” can be substituted with the term “comprising” and is to be treated with similar scope, unless otherwise explicitly used otherwise. As an example, “a basket of fruit including an apple” is to be treated with the same breadth of scope as, “a basket of fruit comprising an apple.”

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities, machine learning components, or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks comprise broadcast technologies (e.g., sub-Hertz, extremely low frequency, very low frequency, low frequency, medium frequency, high frequency, very high frequency, ultra-high frequency, super-high frequency, extremely high frequency, terahertz broadcasts, etc.); Ethernet; X.25; powerline-type networking, e.g., Powerline audio video Ethernet, etc.; femtocell technology; Wi-Fi; worldwide interoperability for microwave access; enhanced general packet radio service; second generation partnership project (2G or 2GPP); third generation partnership project (3G or 3GPP); fourth generation partnership project (4G or 4GPP); long term evolution (LTE); fifth generation partnership project (5G or 5GPP); third generation partnership project universal mobile telecommunications system; third generation partnership project 2; ultra mobile broadband; high speed packet access; high speed downlink packet access; high speed uplink packet access; enhanced data rates for global system for mobile communication evolution radio access network; universal mobile telecommunications system terrestrial radio access network; or long term evolution advanced. As an example, a millimeter wave broadcast technology can employ electromagnetic waves in the frequency spectrum from about 30 GHz to about 300 GHz. These millimeter waves can be generally situated between microwaves (from about 1 GHz to about 30 GHz) and infrared (IR) waves, and are sometimes referred to as extremely high frequency (EHF). The wavelength (λ) for millimeter waves is typically in the 1-mm to 10-mm range.

The term “infer” or “inference” can generally refer to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference, for example, can be employed to identify a specific context or action, or can generate a probability distribution over states of interest based on a consideration of data and events. Inference can also refer to techniques employed for composing higher-level events from a set of events and/or data. Such inference results in the construction of new events or actions from a set of observed events and/or stored event data, whether the events, in some instances, can be correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the processor, facilitate performance of operations, comprising:
in response to determining a thread has failed to acquire a lock, determining an average hold time for threads that have previously acquired the lock; and
comparing the average hold time to a threshold hold time.

2. The system of claim 1, wherein the operations further comprise:
in response to the average hold time being determined to be greater than the threshold hold time, causing the thread to sleep.

3. The system of claim 1, wherein the operations further comprise:
in response to the average hold time being determined to be less than the threshold hold time, causing the thread to spin.

4. The system of claim 1, wherein the threshold hold time is a first threshold hold time, and wherein the operations further comprise:
querying a scheduler for a count of tasks which could be run; and
in response to the average hold time being determined to be greater than a second threshold hold time and less than the first threshold hold time and the count of tasks being determined to be greater than zero, causing the thread to sleep.

5. The system of claim 1, wherein the first threshold and the second threshold are based on an estimated latency of a sleep and wake-up sequence.

6. The system of claim 1, wherein the average hold time is a decaying average.

7. The system of claim 1, wherein the average hold time is updated by threads that acquire the lock.

8. The system of claim 1, wherein the average hold time is an average hold time for a class of purposes associated with a thread currently holding the lock.

9. A method, comprising:
in response to identifying a failure of a thread to acquire a lock, determining, by a system comprising a processor, an average acquire time for threads that have previously acquired the lock; and
comparing, by the system, the average acquire time to a threshold acquire time.

10. The method of claim 9, further comprising:
in response to the average acquire time being determined to be less than the threshold acquire time, causing, by the system, the thread to spin.

11. The method of claim 9, further comprising:
in response to the average acquire time being determined to be greater than the threshold acquire time, causing, by the system, the thread to sleep.

12. The method of claim 9, wherein the threshold acquire time is a first threshold acquire time, and further comprising:
querying a scheduler for a count of tasks that are able to be run; and
in response to the average acquire time being determined to be greater than a second threshold acquire time and less than the first threshold acquire time and the count of tasks being determined to be greater than zero, causing the thread to sleep.

13. The method of claim 12, wherein the first threshold acquire time and the second threshold acquire time are based on an estimated latency of a sleep and wake-up sequence.

14. The method of claim 8, wherein the average acquire time is a decaying average.

15. The method of claim 8, wherein the average acquire time is updated by threads that acquire the lock.

16. A non-transitory computer-readable medium comprising instructions that, in response to execution, cause a system comprising a processor to perform operations, comprising:
obtaining respective hold times for threads with respect to a lock;
based on the respective hold times, determining an average hold time for the threads;
obtaining respective acquire times for the threads with respect to the lock;
based on the respective acquire times, determining an average acquire time for the threads; and
in response to a seeking thread being determined to have failed to acquire the lock, determining whether the seeking thread is going to sleep or spin based on at least one of the average hold time or the average acquire time.

17. The non-transitory computer-readable medium of claim 16, wherein the average hold time is a decaying average.

18. The non-transitory computer-readable medium of claim 16, wherein the average hold time is a moving average.

19. The non-transitory computer-readable medium of claim 16, wherein the operations further comprise:
associating a hold time of the respective hold times with a class based on a purpose of a thread of the threads corresponding to the hold time.

20. The non-transitory computer-readable medium of claim 19, wherein the average hold time is based on hold times associated with the class.
